(19) United States
(12) Patent Application Publication
(10) Pub. No.: US 2026/0329016 A1
(43) Pub. Date: Oct. 22, 2026

(54) MINIATURIZED MT OPTICAL FIBER CONNECTOR AND ADAPTER ASSEMBLY

(71) Applicant: WUHAN YOU'EFU OPTOELECTRONIC TECHNOLOGY CO., LTD., Wuhan (CN)

(72) Inventor: Di ZHANG, Wuhan (CN)

(73) Assignee: WUHAN YOU'EFU OPTOELECTRONIC TECHNOLOGY CO., LTD., Wuhan (CN)

(21) Appl. No.: 19/701,839

(22) Filed: Jun. 9, 2026

Related U.S. Application Data
(63) Continuation of application No. PCT/CN2023/093615, filed on May 11, 2023.

(30) Foreign Application Priority Data
Nov. 9, 2022 (CN) 2022114013891

(51) Int. Cl. G02B 6/38

(52) U.S. Cl. CPC G02B 6/3825; G02B 6/3881; G02B 6/3882; G02B 6/3885; G02B 6/3893

(57) ABSTRACT

The present invention discloses a miniaturized MT optical fiber connector and an adapter assembly. One end of an adapter body is a front end connection part configured to couple and mate with an ordinary multi-core ferrule MPO connector, the other end of the adapter body is a rear end connection part configured to couple and mate with the miniaturized MT optical fiber connector, and an accommodating cavity is formed inside the adapter body; the front end connection part comprises an upper cantilever and a lower cantilever, and the upper cantilever and the lower cantilever define a left relief notch and a right relief notch in the thickness direction of the front end connection part region. The present invention reduces plastic usage and achieves a smaller size, thereby meeting the requirements for module integration and miniaturization.

### CROSS-REFERENCE TO RELATED APPLICATIONS

The present application is a continuation application of the international patent application No. PCT/CN 2023/093615, filed on May 11, 2023, which claims priority to the following Chinese patent application:

Chinese patent application No. 202211401389.1, entitled “Miniaturized MT Optical Fiber Connector and Adapter Assembly”, filed to the China National Intellectual Property Administration on Nov. 9, 2022.

### TECHNICAL FIELD

The present invention belongs to the optical fiber communication technical field, and more particularly relates to a miniaturized MT optical fiber connector and an adapter assembly.

### BACKGROUND

Connections between optical fibers and between optical fibers and equipment are generally realized via connectors. With the explosive growth of information internet and cloud services, the requirement for optical fiber connection density continues to increase. That is, achieving more optical fiber connections per unit volume is required. As human demand for communication rapidly increases, existing communication systems face greater challenges. Among these, speed and energy consumption are two critical factors. There is a growing demand for greater bandwidth in smaller spaces and at lower power consumption. Therefore, multi-core optical fiber connectors capable of parallel optical fiber transmission and reception have been widely adopted.

Currently, conventional multi-core optical fiber connectors (MPOs) have structures including numerous parts, resulting in relatively long product length, large height, and wide width, and occupying excessive wiring space. Meanwhile, as a movable coupling-type butt-joint connector, optical fiber connection typically requires convenient and free decoupling in most applications. However, commercially available connectors, especially small-size connectors, lack convenient decoupling capability, causing significant difficulties in engineering implementation. In particular, the relatively large dimensions of MPO connectors in both width and length directions severely hinder module integration and miniaturization design of MPO connectors. On the other hand, mating between optical fiber connectors is generally achieved via optical fiber adapters. Against the backdrop of demand for small-sized mating space, merely downsizing the connector is far insufficient; and the optical fiber adapter also needs to be downsized to reduce the overall space of the mating electrical component. Currently, conventional multi-core optical fiber MPO adapters are relatively large, particularly in the height direction where dimensional sensitivity is high, featuring thick side walls that result in excessive adapter thickness, thereby causing major layout challenges in module design. Moreover, since adapter materials are typically plastic to provide elasticity at mechanical latching structures, larger adapters degrade electromagnetic shielding performance in module layouts. As is well known, metal materials block and shield electromagnetic shielding signals, whereas plastic materials lack such functionality for electromagnetic signals. In module design, how to expand the use of metal materials while reducing plastic usage remains an ongoing research topic in the electromagnetic shielding field. At that, a more rational technical solution is required to address the technical problems present in the prior art.

### SUMMARY

An object of the present invention is to provide a miniaturized MT optical fiber connector and an adapter assembly to solve at least one of the above-mentioned problems existing in the prior art.

In order to achieve the above objective, the present invention adopts the following technical solutions.

A miniaturized MT optical fiber connector and an adapter assembly are disclosed, including a miniaturized MT optical fiber connector, and an adapter body connecting the miniaturized MT optical fiber connector and an ordinary multi-core ferrule MPO connector, wherein one end of the adapter body is a front end connection part for coupling and docking with the ordinary multi-core ferrule MPO connector, and the other end of the adapter body is a rear end connection part for coupling and docking with the miniaturized MT optical fiber connector; an accommodating cavity communicating the front end connection part and the rear end connection part is provided inside the adapter body; the front end connection part comprises an upper cantilever located on an upper side of the accommodating cavity and a lower cantilever located on a lower side of the accommodating cavity, wherein the upper cantilever and the lower cantilever form a left relief notch and a right relief notch in a thickness direction of a region of the front end connection part; the miniaturized MT optical fiber connector comprises a multi-core ferrule, a connector housing, and two collimating PINs; the connector housing is provided thereon with at least one cantilever beam, and the cantilever beam is provided thereon with an outward protrusion configured to mate with the rear end connection part; the connector housing is provided thereon with a rear mounting groove communicating its inner cavity with its outside; and a stepped groove for accommodating the collimating PINs is provided in the rear mounting groove, and the two collimating PINs are both mounted on the multi-core ferrule and connected within the stepped groove.

As a preferred technical solution of the present invention, the collimating PIN has a cylindrical structure, and an annular recess is formed at a tail portion of the collimating PIN; a C-shaped limiting protrusion is provided in the stepped groove; the C-shaped limiting protrusion communicates with the rear mounting groove via its opening, and a width of the opening of the C-shaped limiting protrusion is smaller than an inner diameter of the C-shaped limiting protrusion; and the C-shaped limiting protrusion in the stepped groove mates and clamps with the annular recess of the collimating PIN, and the annular recess is clearance-fitted with an inner wall of the C-shaped limiting protrusion.

As a preferred technical solution of the present invention, the adapter body is made of elastic plastic, and the connector housing is made of elastic plastic or an elastic metal sheet.

As a preferred technical solution of the present invention, the multi-core ferrule is provided with two parallel collimating holes, and each of the two collimating PINs is installed in one collimating hole in a mating way.

As a preferred technical solution of the present invention, the cantilever beam at least partially sinks into the connector housing in a height direction of the connector housing and is partially suspended relative to the connector housing; an upper side and/or a lower side of the connector housing is provided with a side recess corresponding to the cantilever beam, and the cantilever beam is disposed within the corresponding side recess; a dimension of the side recess is greater than a portion of the cantilever beam sinking into the side recess, and a movable gap exists between the side recess and a left side and a right side of the cantilever beam; and an elastic deformation gap is defined between a bottom of the side recess and the cantilever beam, and a height of the elastic deformation gap is greater than a height of the outward protrusion.

As a preferred technical solution of the present invention, the left relief notch and the right relief notch both communicate with the accommodating cavity such that the accommodating cavity extends through the thickness direction of the front end connection part, and the left relief notch and the right relief notch extend through an upper side face and a lower side face of an entire front end connection part, so that a width of the adapter body in the left-right direction is relatively small.

As a preferred technical solution of the present invention, a front end of the upper cantilever and a front end of the lower cantilever are each provided with a buckle, and two buckles mate and clamp with a mechanical latch of the ordinary multi-core ferrule MPO connector.

As a preferred technical solution of the present invention, the rear end connection part is provided with at least one limiting window, and the limiting window engages with the outward protrusion via a snap-fit.

As a preferred technical solution of the present invention, the limiting window is provided at an upper end and/or a lower end of the rear end connection part, a directional key boss is provided on an inner side wall of the rear end connection part, and one side of the rear mounting groove is slidably connected to the directional key boss.

As a preferred technical solution of the present invention, an avoidance chute is formed on the inner wall of the upper end and/or the inner wall of the lower end of the rear end connection part.

The advantageous effects are as follows. In the present invention, the front end connection part and the rear end connection part of the adapter body connect the miniaturized MT optical fiber connector and the ordinary multi-core ferrule MPO connector. One end of the ordinary multi-core ferrule MPO connector and one end of the miniaturized MT optical fiber connector are both accommodated within the accommodating cavity, enabling mating between the ordinary multi-core ferrule MPO connector and the miniaturized MT optical fiber connector, while ensuring stable connection between the ordinary multi-core ferrule MPO connector and the miniaturized MT optical fiber connector under the action of the adapter body. Specifically, the front end connection part connects to the ordinary multi-core ferrule MPO connector via the upper cantilever and the lower cantilever. In the thickness direction of the front end connection part region, the upper cantilever and the lower cantilever define a left relief notch and a right relief notch. This configuration can not only ensure stable connection between the front end connection part and the ordinary multi-core ferrule MPO connector, but also—without changing the material of the adapter, i.e., retaining the same plastic material as in the prior art—reduces the two side walls at the front end of the conventional adapter by virtue of the left relief notch and the right relief notch, thereby reducing plastic usage and enabling a smaller overall dimension of the front end connection part. The removed plastic portion is externally provided with a metal module structure providing electromagnetic shielding. At that, electromagnetic leakage is not a concern.

The present invention provides at least one cantilever beam on the connector housing, and the cantilever beam is provided with an outward protrusion configured to engage with the adapter, thereby achieving quick assembly and disassembly. Therefore, free decoupling can be conveniently realized in most applications. The connector housing is provided with a rear mounting groove that communicates its inner cavity with its outside, allowing the optical fibers connected to the multi-core ferrule to enter the inner cavity of the connector housing via the rear mounting groove. This enables flexible sequencing of the assembly between the multi-core ferrule and the connector housing. The connector housing may be assembled with the multi-core ferrule prior to combining the multi-core ferrule with the optical fibers, or alternatively, the connector housing may be assembled with the multi-core ferrule after the multi-core ferrule has been combined with the optical fibers, and both approaches facilitate convenient connection. A stepped groove for accommodating the collimating PIN is formed within the rear mounting groove. Both collimating PINs are mounted on the multi-core ferrule and engaged with the stepped groove, thereby forming a mounting and fixing structure for the collimating PINs. This arrangement facilitates connection and ensures structural stability, thereby limiting the multi-core ferrule and further facilitating the installation of the multi-core ferrule. Both collimating PINs are mounted on the multi-core ferrule to complete the basic functional configuration. Moreover, the tail end of the collimating PIN is snap-fitted into the stepped groove, which limits the collimating PIN and ensures its stability. As a result, the miniaturized MT optical fiber connector features a simple structure. Its dimensions are reduced in both the length and width directions, thereby satisfying the design requirements of modular integration and miniaturization enabled by the use of multi-core ferrules.

### BRIEF DESCRIPTION OF DRAWINGS

FIG. 1 is a schematic structural view of the present invention prior to assembly with an ordinary multi-core ferrule MPO connector;

FIG. 2 is a schematic view illustrating an assembly of the present invention with an ordinary multi-core ferrule MPO connector;

FIG. 3 is a perspective view of an adapter body according to the present invention;

FIG. 4 is a top view of an adapter body according to the present invention;

FIG. 5 is a front view of an adapter body according to the present invention;

FIG. 6 is a schematic structural view of an adapter body of the present invention prior to module installation;

FIG. 7 is a schematic structural view illustrating a connector housing and a collimating PIN prior to mating according to the present invention;

FIG. 8 is a schematic sectional view of a miniaturized MT optical fiber connector according to the present invention;

FIG. 9 is a schematic view illustrating an assembly of a connector housing and a collimating PIN according to the present invention;

FIG. 10 is a schematic structural view of a multi-core ferrule of the present invention;

FIG. 11 is a schematic view illustrating the assembled structure shown in Embodiment 2 and Embodiment 3 of the present invention;

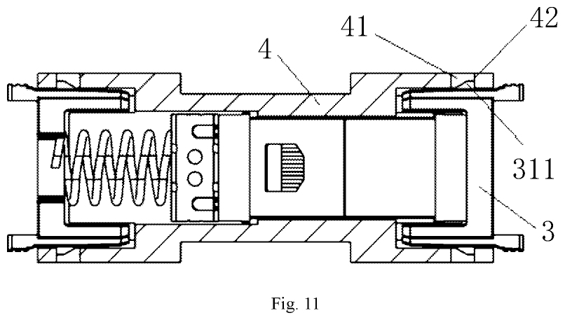

FIG. 12 is a schematic structural view of a conventional adapter;

FIG. 13 is a schematic structural view of a conventional multi-core optical fiber connector;

FIG. 14 is a schematic view illustrating a length comparison between a miniaturized MT optical fiber connector according to the present invention and a conventional multi-core optical fiber connector; and

FIG. 15 is an exploded perspective view of a conventional multi-core optical fiber connector.

### DETAILED DESCRIPTION OF THE EMBODIMENTS

To more clearly illustrate the technical solutions of the embodiments of the present invention or those of the prior art, the present invention will be briefly described below with reference to the accompanying drawings and the description of the embodiments or the prior art. Clearly, the following description relating to the structural features of the drawings represents only some embodiments of the present invention. For those skilled in the art, other drawings may be derived from these drawings without inventive effort. It needs to be noted that the descriptions of these embodiments are intended to aid understanding of the present invention and do not constitute limitations on the scope of the present invention.

### Embodiment 1

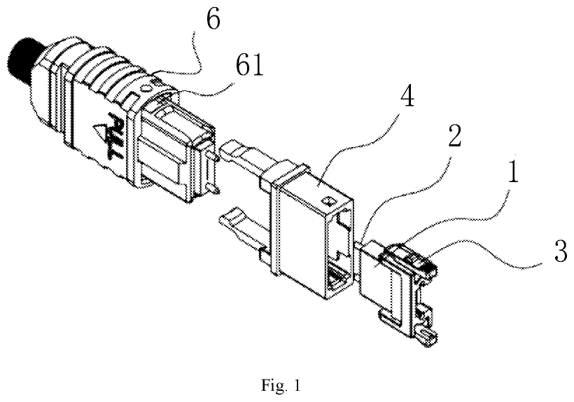

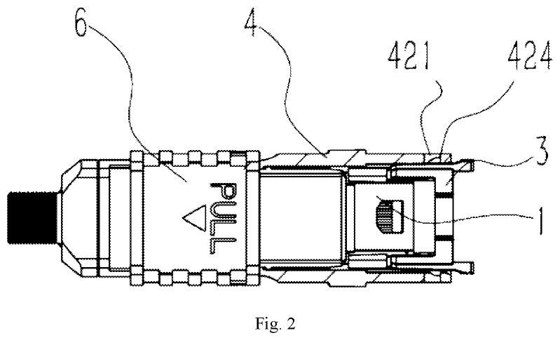

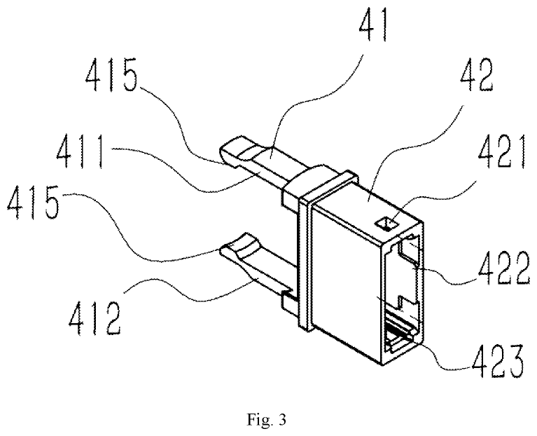

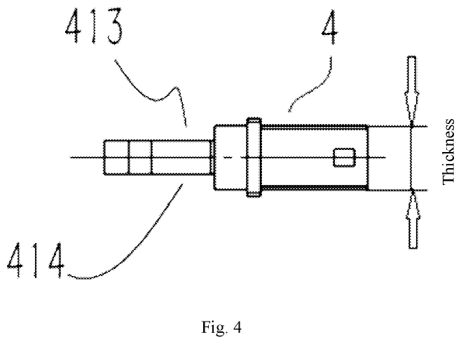

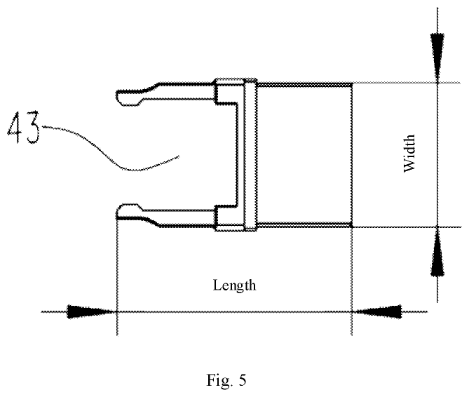

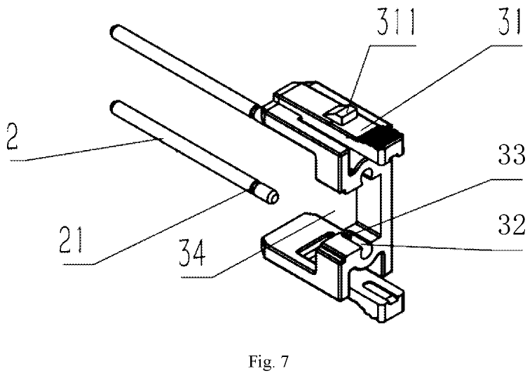

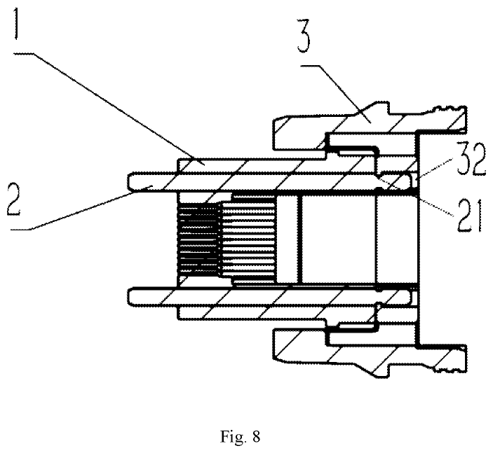

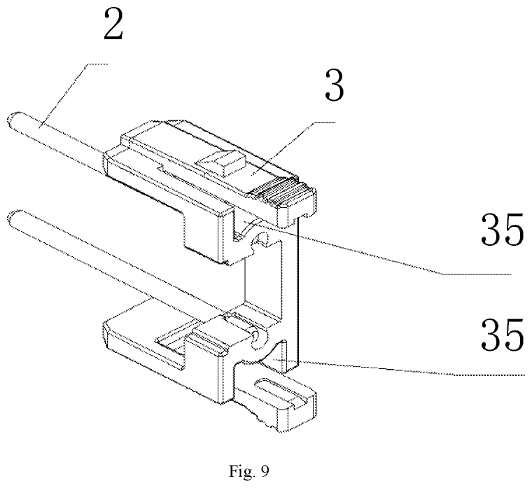

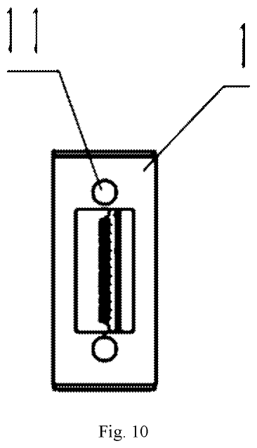

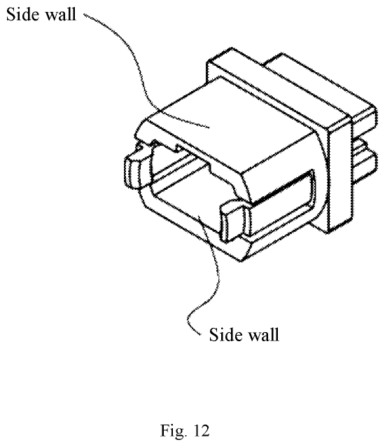

As shown in FIGS. 1 to 10, the present embodiment provides a miniaturized MT optical fiber connector and an adapter assembly, comprising a miniaturized MT optical fiber connector and an adapter body 4 configured to connect the miniaturized MT optical fiber connector and an ordinary multi-core ferrule MPO connector 6. One end of the adapter body 4 is a front end connection part 41 for coupling and docking with the ordinary multi-core ferrule MPO connector 6, while the other end of the adapter body 4 defines a rear end connection part 42 adapted for coupling and docking with the miniaturized MT optical fiber connector. An accommodating cavity 43, which communicates the front end connection part 41 and the rear end connection part 42, is formed inside the adapter body 4. One end of the ordinary multi-core ferrule MPO connector 6 and one end of the miniaturized MT optical fiber connector are both accommodated within the accommodating cavity 43 to realize the butt-joint connection of the ordinary multi-core ferrule MPO connector 6 and the miniaturized MT optical fiber connector, and the adapter body 4 ensures a stable connection between the ordinary multi-core ferrule MPO connector 6 and the miniaturized MT optical fiber connector. Specifically, the front end connection part 41 comprises an upper cantilever 411 positioned on the upper side of the accommodating cavity 43 and a lower cantilever 412 positioned at the lower side of the accommodating cavity 43. The front end connection part 41 connects to the ordinary multi-core ferrule MPO connector 6 via the upper cantilever 411 and the lower cantilever 412. In the thickness direction of the front end connection part 41 region, the upper cantilever 411 and the lower cantilever 412 define a left relief notch 413 and a right relief notch 414, respectively. This configuration not only ensures stable connection between the front end connection part 41 and the ordinary multi-core ferrule MPO connector 6 but also—while retaining the same plastic material used in conventional adapters—reduces the two side walls at the front end of the conventional adapter (e.g., as shown in FIG. 12) by virtue of the left relief notch 413 and the right relief notch 414, thereby reducing plastic usage and enabling a smaller overall size of the front end connection part 41. In practice, the removed plastic portions are externally provided with a metallic module structure providing electromagnetic shielding. At that, electromagnetic leakage is not a concern.

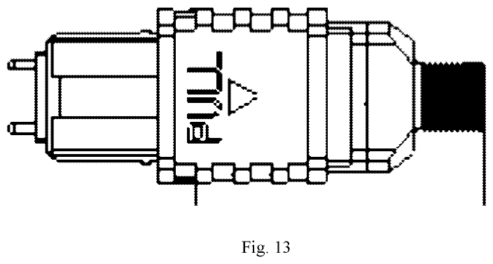

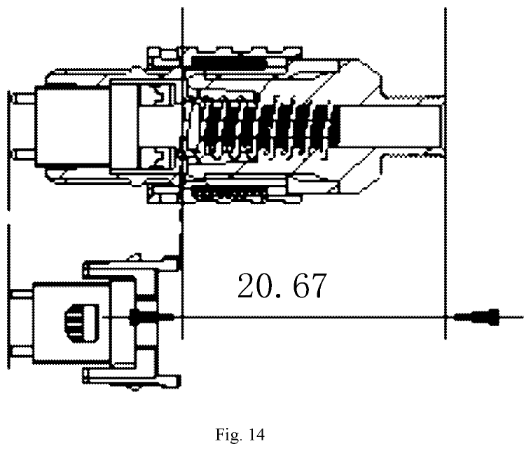

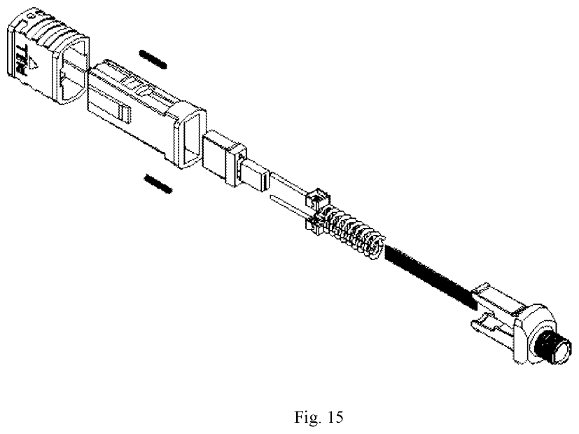

The miniaturized MT optical fiber connector comprises a multi-core ferrule 1, a connector housing 3, and two collimating PINs 2. The connector housing 3 is provided with at least one cantilever beam 31, and the cantilever beam 31 is provided with an outward protrusion 311 configured to cooperate with the rear end connection part 42, thereby achieving quick assembly and disassembly. Therefore, free decoupling can be conveniently realized in most applications. The connector housing 3 is provided with a rear mounting groove 34 that communicates its inner cavity with its outside, allowing the optical fibers connected to the multi-core ferrule 1 to enter the inner cavity of the connector housing 3 via the rear mounting groove 34. This enables flexible sequencing of the assembly between the multi-core ferrule 1 and the connector housing 3: the connector housing may be assembled with the multi-core ferrule prior to combining the multi-core ferrule with the optical fibers, or alternatively, the connector housing may be assembled with the multi-core ferrule after the multi-core ferrule has been combined with the optical fibers, and both approaches facilitate convenient connection. A stepped groove 32 for accommodating the collimating PIN 2 is formed within the rear mounting groove 34. Both collimating PINs 2 are mounted on the multi-core ferrule 1 and engaged with the stepped groove 32, thereby forming a mounting and fixing structure for the collimating PINs 2. This arrangement facilitates connection and ensures structural stability, thereby limiting the multi-core ferrule 1 and further facilitating the installation of the multi-core ferrule 1. Both collimating PINs 2 are mounted on the multi-core ferrule 1 to complete the basic functional configuration. Moreover, the tail end of the collimating PIN 2 is snap-fitted into the stepped groove 32, which limits the collimating PIN 2 and ensures its stability. As a result, the miniaturized MT optical fiber connector features a simple structure. Compared with the prior art shown in FIGS. 13, 14, and 15, its dimensions are reduced in both the length and width directions, thereby satisfying the design requirements of modular integration and miniaturization enabled by the use of multi-core ferrules.

In the present invention, the front end connection part 41 and the rear end connection part 42 of the adapter body 4 connect the miniaturized MT optical fiber connector and the ordinary multi-core ferrule MPO connector 6. One end of the ordinary multi-core ferrule MPO connector 6 and one end of the miniaturized MT optical fiber connector are both accommodated within the accommodating cavity 43, enabling mating between the ordinary multi-core ferrule MPO connector 6 and the miniaturized MT optical fiber connector, while ensuring stable connection between the ordinary multi-core ferrule MPO connector 6 and the miniaturized MT optical fiber connector under the action of the adapter body 4. Specifically, the front end connection part 41 connects to the ordinary multi-core ferrule MPO connector 6 via the upper cantilever 411 and the lower cantilever 412. In the thickness direction of the front end connection part 41 region, the upper cantilever 411 and the lower cantilever 412 define a left relief notch 413 and a right relief notch 414. This configuration can not only ensure stable connection between the front end connection part 41 and the ordinary multi-core ferrule MPO connector 6, but also, without changing the material of the adapter, i.e., retaining the same plastic material as in the prior art, reduces the two side walls at the front end of the conventional adapter by virtue of the left relief notch 413 and the right relief notch 414, thereby reducing plastic usage and enabling a smaller overall dimension of the front end connection part 41. The removed plastic portion is externally provided with a metal module structure providing electromagnetic shielding. At that, electromagnetic leakage is not a concern.

The present invention provides at least one cantilever beam 31 on the connector housing 3, and the cantilever beam 31 is provided with an outward protrusion 311 configured to engage with the adapter, thereby achieving quick assembly and disassembly. Therefore, free decoupling can be conveniently realized in most applications. The connector housing 3 is provided with a rear mounting groove 34 that communicates its inner cavity with its outside, allowing the optical fibers connected to the multi-core ferrule 1 to enter the inner cavity of the connector housing 3 via the rear mounting groove 34. This enables flexible sequencing of the assembly between the multi-core ferrule 1 and the connector housing 3. The connector housing 3 may be assembled with the multi-core ferrule prior to combining the multi-core ferrule with the optical fibers, or alternatively, the connector housing may be assembled with the multi-core ferrule after the multi-core ferrule has been combined with the optical fibers, and both approaches facilitate convenient connection. A stepped groove 32 for accommodating the collimating PIN 2 is formed within the rear mounting groove 34. Both collimating PINs 2 are mounted on the multi-core ferrule 1 and engaged with the stepped groove 32, thereby forming a mounting and fixing structure for the collimating PINs 2. This arrangement facilitates connection and ensures structural stability, thereby limiting the multi-core ferrule 1 and further facilitating the installation of the multi-core ferrule 1. Both collimating PINs 2 are mounted on the multi-core ferrule 1 to complete the basic functional configuration. Moreover, the tail end of the collimating PIN 2 is snap-fitted into the stepped groove 32, which limits the collimating PIN 2 and ensures its stability. As a result, the miniaturized MT optical fiber connector features a simple structure. Its dimensions are reduced in both the length and width directions, thereby satisfying the design requirements of modular integration and miniaturization enabled by the use of multi-core ferrules.

As a preferred implementation mode of this embodiment, it needs to be further explained that the collimating PIN 2 is of a cylindrical structure, and an annular recess 21 is provided at the tail portion of the collimating PIN 2; a C-shaped limiting protrusion 33 is provided in the stepped groove 32, and the C-shaped limiting protrusion 33 communicates with the rear mounting groove 34 via its opening; the width of the opening of the C-shaped limiting protrusion 33 is smaller than the inner diameter of the C-shaped limiting protrusion 33; and the C-shaped limiting protrusion 33 in the stepped groove 32 engages and snaps into the annular recess 21 of the collimating PIN 2. This configuration facilitates convenient and stable snap-fitting of the collimating PIN 2 into the C-shaped limiting protrusion 33 of the stepped groove 32, prevents the annular recess 21 from disengaging freely from the opening of the C-shaped limiting protrusion 33, and ensures a clearance fit between the annular recess 21 and the inner wall of the C-shaped limiting protrusion 33, thereby allowing the collimating PIN 2 to oscillate relative to the connector housing 3.

As a preferred implementation mode of this embodiment, it should be further explained that the adapter body 4 is made of elastic plastic, and the material of the adapter body 4 remains unchanged; and the connector housing 3 is made of elastic plastic or an elastic metal sheet, thereby facilitating snap-fitting engagement between the annular recess 21 at the tail portion of the collimating PIN 2, and the C-shaped limiting protrusion 33, and ensuring the stability during the engagement.

As a preferred implementation mode of this embodiment, it should be further explained that the multi-core ferrule 1 is provided with two mutually parallel collimating holes 11, and each of the two collimating PINs 2 is respectively installed in one collimating hole 11 in a matched manner, thereby enabling easy and rapid assembly and engagement of the two collimating PINs 2 with the multi-core ferrule 1.

As a preferred implementation mode of this embodiment, it should be further explained that the cantilever beam 31 at least partially sinks relative to the connector housing 3 in the height direction of the connector housing 3 and is partially suspended relative to the connector housing 3; one end of the cantilever beam 31 is connected to the connector housing 3, and an outward protrusion 311 is provided on the cantilever beam 31, such that the suspended portion of the cantilever beam 31 can undergo bending deformation, thereby enabling the outward protrusion 311 on the cantilever beam 31 to engage and snap-fit with the adapter 4; a side recess 35 corresponding to the cantilever beam 31 is provided on the upper side and/or lower side of the connector housing 3, and the cantilever beam 31 is accommodated within the corresponding side recess 35; the dimensions of the side recess 35 are greater than those of the portion of the cantilever beam 31 sinking into the side recess 35, and movable gaps exist between the side recess 35 and the left and right sides of the cantilever beam 31; and an elastic deformation gap exists between the bottom of the side recess 35 and the cantilever beam 31, and the height of this elastic deformation gap exceeds the height of the outward protrusion 311, ensuring sufficient elastic space for the outward protrusion 311 to allow controlled deformation of the cantilever beam 31 during mating connection with the adapter 4, thereby enabling rapid engagement and snap-fitting of the outward protrusion 311 with the adapter 4.

As a preferred implementation mode, it should be further explained that the connector housing 3 and the two collimating PINs 2 may be integrally molded to provide collimating PINs 2 with relaxed dimensional tolerance requirements, thereby improving the design cost and assembly efficiency of the equipment.

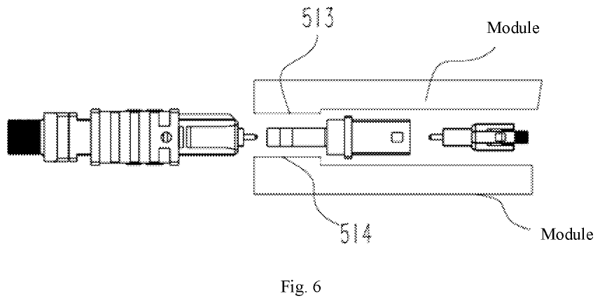

As a preferred implementation mode of this embodiment, it should be further explained that both the left relief notch 413 and the right relief notch 414 communicate with the accommodating cavity 43 such that the accommodating cavity 43 can extend through the thickness direction of the front end connection part 41. The left relief notch 413 and the right relief notch 414 extend across the upper side face and lower side face of the entire front end connection part 41, resulting in a relatively small width of the adapter body 4 in the left-right direction. During module installation, the module is provided with a left protrusion 513 corresponding to the left relief notch 413 and a right protrusion 514 corresponding to the right relief notch 414, as shown in FIG. 6. The left protrusion 513 engages with the left relief notch 413, allowing the left protrusion 513 of the module to enter the left side of the accommodating cavity 43 through the left relief notch 413; and the right protrusion 514 engages with the right relief notch 414, allowing the right protrusion 514 of the module to enter the right side of the accommodating cavity 43 through the right relief notch 414. Together, the upper cantilever 411, the lower cantilever 412, the left protrusion 513 of the module, and the right protrusion 514 of the module form, in the up, down, left, and right directions, a passage configured to limit all four faces of an ordinary multi-core ferrule MPO connector 6.

As a preferred implementation mode of this embodiment, it should be further explained that buckles 415 are provided at the front end of the upper cantilever 411 and the front end of the lower cantilever 412, respectively; and the two buckles 415 engage with the mechanical latch 61 of the ordinary multi-core ferrule MPO connector 6, resulting in a simple connection method with good stability.

As a preferred implementation mode of this embodiment, it should be further explained that the rear end connection part 42 is provided with at least one limiting window 421, and the limiting window 421 engages with the outward protrusion 311. At that, the connection method is simple and stable, and does not require a complex structure, thereby facilitating dimensional control. Further preferably, a vertical stop face 424 is formed on a face of the limiting window 421 away from the ordinary multi-core ferrule MPO connector 6; and at the vertical stop face 424, the outward protrusion 102 contacts the limiting window 421 in a face-contacting way, ensuring the stability of the outward protrusion 102 within the limiting window 421. That is, ensuring stable connection between the miniaturized MT optical fiber connector and the adapter body 4 can be achieved.

As a preferred implementation mode of this embodiment, it should be further explained that the limiting window 421 is arranged at the upper end and/or the lower end of the rear end connection part 42. When a single limiting window 421 is provided, it may be located at either the upper end or the lower end; and when two limiting windows 421 are provided, they may be arranged at the upper end and the lower end, respectively, thereby offering strong design flexibility. A directional key boss 422 is provided on an inner side wall of the rear end connection part 42, and one side of the rear mounting groove 34 slidably engages with the directional key boss 422. This achieves a fool-proof design, ensuring correct alignment of the fiber sequence in the miniaturized MT optical fiber connector with the fiber sequence in the adapter body 4. Correct mating of the fiber sequence in the miniaturized MT optical fiber connector with the adapter body 4 occurs only when the directional key boss 422 aligns with one side of the rear mounting groove 34. Otherwise, insertion cannot be performed.

As a preferred implementation mode of this embodiment, it should be further explained that an avoidance chute 423 is provided on the inner wall of the upper end and/or the inner wall of the lower end of the rear end connection part 42, for sliding engagement with the miniaturized MT optical fiber connector. By cooperating with the elastic cantilever beam 101 via one or two avoidance chutes 423, the installation of the miniaturized MT optical fiber connector becomes more stable and the miniaturized MT optical fiber connector is limited.

### Embodiment 2

As shown in FIG. 12, this embodiment provides another miniaturized MT optical fiber connector based on the technical solution of embodiment 1. It differs from the miniaturized MT optical fiber connector of embodiment 1 in that, when the counterpart optical fiber connector paired with the miniaturized MT optical fiber connector is also a miniaturized MT optical fiber connector, it is sufficient to correspondingly optimize the adapter structure such that adapter windows 421—configured to mate and cooperate with the miniaturized MT optical fiber connector—are provided at two adapted ends. At one end, proximal to the tail portion of the connector housing 3, inside each adapter window 421 at the two ends, a vertical stop face 424 is provided to prevent the disengagement of the outward protrusion 311, thereby preventing the outward protrusion 311 from withdrawing from the adapter window 421. Moreover, the two connector housings 3 are matched with the adapter windows 421 at the two ends of the adapter body 4, enabling the two miniaturized MT optical fiber connectors to constitute a pair of nodes or systems for optical transmission.

### Embodiment 3

As shown in FIG. 12, this embodiment provides another miniaturized MT optical fiber connector based on the technical solution of embodiment 2. It differs from the miniaturized MT optical fiber connector of embodiment 2 in that, to impart a certain pretightening force to the mating end faces of the two miniaturized MT optical fiber connectors, an elastic device may be directly provided between the multi-core ferrule and the connector housing of one of the miniaturized MT optical fiber connectors. It is sufficient to correspondingly optimize the adapter structure such that adapter windows 421—configured to mate and cooperate with the miniaturized MT optical fiber connector—are provided at two adapted ends. At one end, proximal to the tail portion of the connector housing 3, inside each adapter window 421 at the two ends, a vertical stop face 424 is provided to prevent the disengagement of the outward protrusion 311, thereby preventing the outward protrusion 311 from withdrawing from the adapter window 421. Moreover, the two connector housings 3 are matched with the adapter windows 421 at the two ends of the adapter body 4, enabling the two miniaturized MT optical fiber connectors to constitute a pair of nodes or systems for optical transmission. Additionally, a certain pretightening force is achieved at the end faces of the two ferrules, enhancing the reliability and stability of connector mating.

The above embodiments are merely illustrative of the technical solutions of the present invention and are not intended to be limiting thereof. Although the present invention has been described in detail with reference to the foregoing examples, those skilled in the art will appreciate that: the technical solutions recited concerning the above examples can still be modified, or some of the technical features thereof can be equivalently replaced. Such modifications or substitutions do not cause the essence of the corresponding technical solutions to depart from the spirit and scope of the technical solutions of the embodiments of the present invention. For example, the scenarios where the technical concept and technical solution of the present invention may be applied to all currently available and future optical fiber connectors, as well as related opto-electronic hybrid connectors and adapters, such as LC type, SC type, ST type, FC type, MPO type, and MT type optical fiber connectors and adapters.

Finally, it should be noted that the foregoing description relates to preferred embodiments of the invention and is not intended to limit the protection scope of the invention. Any modifications, equivalents, improvements, etc. that come within the spirit and principles of the present invention are intended to be included within the scope of the present invention.

What is claimed is:

1. A miniaturized MT optical fiber connector and an adapter assembly, comprising a miniaturized MT optical fiber connector, and an adapter body (4) connecting the miniaturized MT optical fiber connector and an ordinary multi-core ferrule MPO connector (6), wherein one end of the adapter body (4) is a front end connection part (41) for coupling and docking with the ordinary multi-core ferrule MPO connector (6), and the other end of the adapter body (4) is a rear end connection part (42) for coupling and docking with the miniaturized MT optical fiber connector; an accommodating cavity (43) communicating the front end connection part (41) and the rear end connection part (42) is provided inside the adapter body (4); the front end connection part (41) comprises an upper cantilever (411) located on an upper side of the accommodating cavity (43) and a lower cantilever (412) located on a lower side of the accommodating cavity (43), wherein the upper cantilever (411) and the lower cantilever (412) form a left relief notch (413) and a right relief notch (414) in a thickness direction of a region of the front end connection part (41); the miniaturized MT optical fiber connector comprises a multi-core ferrule (1), a connector housing (3), and two collimating PINs (2); the connector housing (3) is provided thereon with at least one cantilever beam (31), and the cantilever beam (31) is provided thereon with an outward protrusion (311) configured to mate with the rear end connection part (42); the connector housing (3) is provided thereon with a rear mounting groove (34) communicating its inner cavity with its outside; and a stepped groove (32) for accommodating the collimating PINs (2) is provided in the rear mounting groove (34), and the two collimating PINs (2) are both mounted on the multi-core ferrule (1) and connected within the stepped groove (32).

2. The miniaturized MT optical fiber connector and adapter assembly according to claim 1, wherein the collimating PIN (2) has a cylindrical structure, and an annular recess (21) is formed at a tail portion of the collimating PIN (2); a C-shaped limiting protrusion (33) is provided in the stepped groove (32); the C-shaped limiting protrusion (33) communicates with the rear mounting groove (34) via its opening, and a width of the opening of the C-shaped limiting protrusion (33) is smaller than an inner diameter of the C-shaped limiting protrusion (33); and the C-shaped limiting protrusion (33) in the stepped groove (32) mates and clamps with the annular recess (21) of the collimating PIN (2), and the annular recess (21) is clearance-fitted with an inner wall of the C-shaped limiting protrusion (33).

3. The miniaturized MT optical fiber connector and adapter assembly according to claim 1, wherein the adapter body (4) is made of elastic plastic, and the connector housing (3) is made of elastic plastic or an elastic metal sheet.

4. The miniaturized MT optical fiber connector and adapter assembly according to claim 1, wherein the multi-core ferrule (1) is provided thereon with two mutually parallel collimating holes (11), and each of the two collimating PINs (2) is installed in one collimating hole (11) in a mating way.

5. The miniaturized MT optical fiber connector and adapter assembly according to claim 1, wherein the cantilever beam (31) at least partially sinks into the connector housing (3) in a height direction of the connector housing (3) and is partially suspended relative to the connector housing (3); an upper side and/or a lower side of the connector housing (3) is provided with a side recess (35) corresponding to the cantilever beam (31), and the cantilever beam (31) is disposed within the corresponding side recess (35); a dimension of the side recess (35) is greater than a portion of the cantilever beam (31) sinking into the side recess (35), and a movable gap exists between the side recess (35) and a left side and a right side of the cantilever beam (31); and an elastic deformation gap is defined between a bottom of the side recess (35) and the cantilever beam (31), and a height of the elastic deformation gap is greater than a height of the outward protrusion (311).

6. The miniaturized MT optical fiber connector and adapter assembly according to claim 1, wherein the left relief notch (413) and the right relief notch (414) both communicate with the accommodating cavity (43) such that the accommodating cavity (43) extends through the thickness direction of the front end connection part (41), and the left relief notch (413) and the right relief notch (414) extend through an upper side face and a lower side face of an entire front end connection part (41), so that a width of the adapter body (4) in the left-right direction is relatively small.

7. The miniaturized MT optical fiber connector and adapter assembly according to claim 1, wherein a front end of the upper cantilever (411) and a front end of the lower cantilever (412) are each provided with a buckle (415), and two buckles (415) mate and clamp with a mechanical latch (61) of the ordinary multi-core ferrule MPO connector (6).

8. The miniaturized MT optical fiber connector and adapter assembly according to claim 7, wherein the rear end connection part (42) is provided with at least one limiting window (421), and the limiting window (421) mates and clamps with the outward protrusion (311).

9. The miniaturized MT optical fiber connector and adapter assembly according to claim 8, wherein the limiting window (421) is provided at an upper end and/or a lower end of the rear end connection part (42), a directional key boss (422) is provided on an inner side wall of the rear end connection part (42), and one side of the rear mounting groove (34) is slidably connected to the directional key boss (422).

10. The miniaturized MT optical fiber connector and adapter assembly according to claim 8, wherein an avoidance chute (423) is provided on an inner wall of an upper end of the rear end connection part (42) and/or on an inner wall of a lower end of the rear end connection part (42).
